(19) United States
(12) Patent Application Publication
(10) Pub. No.: US 2012/0254610 A1
(43) Pub. Date: Oct. 4, 2012

(54) REMOTE DISABLING OF APPLICATIONS

(75) Inventors: Ziquan Li, Redmond, WA (US); Sanjeev Dwivedi, Sammamish, WA (US); Sunil S. Kadam, Redmond, WA (US); Alwin Vyhmeister, Seattle, WA (US); Ariye M. Cohen, Bellevue, WA (US)

(73) Assignee: Microsoft Corporation, Redmond, WA (US)

(21) Appl. No.: 13/076,460

(22) Filed: Mar. 31, 2011

(51) Int. Cl. H04L 9/32

(52) U.S. Cl. 713/158

(57) ABSTRACT

The claimed subject matter provides a method for revoking licensed software in a computing environment. An exemplary method includes receiving a machine ID from a computer system. An application program and a license credential for the application program are sent to the computer system. Subsequently, upon theft or other loss of the computer system, a request to revoke the license credential is received. The request identifies the machine ID. When the computer system subsequently initiates a connection, the connection is detected based on the machine ID. An indication that the license credential for the application program is revoked is sent to the computer system. When the application program is later initiated, its operation is disabled because of the revocation of the license credential.

### BACKGROUND

If a computer system is stolen or otherwise lost, the owner of the computer system may have to re-purchase licensed software. Moreover, a theif of the computer system may reap the benefit of the licensed software purchased by the rightful owner of the computer system.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The claimed subject relates to a method for revoking software licenses when a computer system has been stolen or otherwise lost. An exemplary method includes receiving a machine ID from a computer system. An application program and a license credential for the application program are sent to the computer system. Subsequently, upon theft or other loss of the computer system, a request to revoke the license credential is received. The request identifies the machine ID. When the computer system subsequently attempts to connect to a network, the connection is detected based on the machine ID. An indication that the license credential for the application program is revoked is then sent to the computer system, rendering the application program inoperable.

One embodiment of the claimed subject matter relates to a system for revoking licensed software. An exemplary system for revoking licensed software comprises a processing unit and a system memory. The system memory stores code configured to direct the processing unit to receive a machine ID from a computer system. Other code stored in the system memory directs the processing unit to send requested software and a license credential for the requested software to the computer system. Code stored in the system memory further directs the processing unit to receive a request to revoke the license credential, the request identifying the machine ID. Additional code directs the processing unit to designate the license credential for the requested software to be revoked in response to the request. Still other code in the system memory directs the processing unit to detect a connection by the computer system based on the machine ID. Further code stored in the system memory directs the processing unit to send to the computer system an indication that the license credential for the requested software is revoked.

Another embodiment relates to one or more computer-readable storage media that store code for revoking licensed software for stolen or otherwise unavailable computer systems. The code for revoking software licenses is configured to direct a processing unit to receive an identifier from a computer system. Other code directs a processing unit to send requested software and a license credential for the requested software to the computer system. Additional code directs a processing unit to receive a request to revoke the license credential, the request including the identifier. Yet additional code directs a processing unit to designate the license credential for the requested software to be revoked in response to the request. Code further directs a processing unit to detect a connection by the computer system based on recognizing the identifier. Finally, additional code directs a processing unit to send an indication that the license credential for the requested software is revoked to the computer system.

### BRIEF DESCRIPTION OF THE DRAWINGS

FIG. 1 is a block diagram of a system in which a method of remotely disabling software according to the subject innovation may be performed;

FIG. 2 is a process flow diagram of a method of remotely disabling licensed software according to the subject innovation;

FIG. 3 is a block diagram of an exemplary networking environment wherein aspects of the claimed subject matter can be employed; and

FIG. 4 is a block diagram of an exemplary operating environment for implementing various aspects of the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media.

Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for wireless signals and the like.

Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

The subject innovation provides a way to disable licensed software on a computer system that has been stolen or otherwise lost. Thus, the licensee of the software may be able to obtain a replacement license to use the software without having to purchase an additional license. In addition, a thief who unlawfully obtains possession of licensed software may be deprived of the benefit of the license and use of the software.

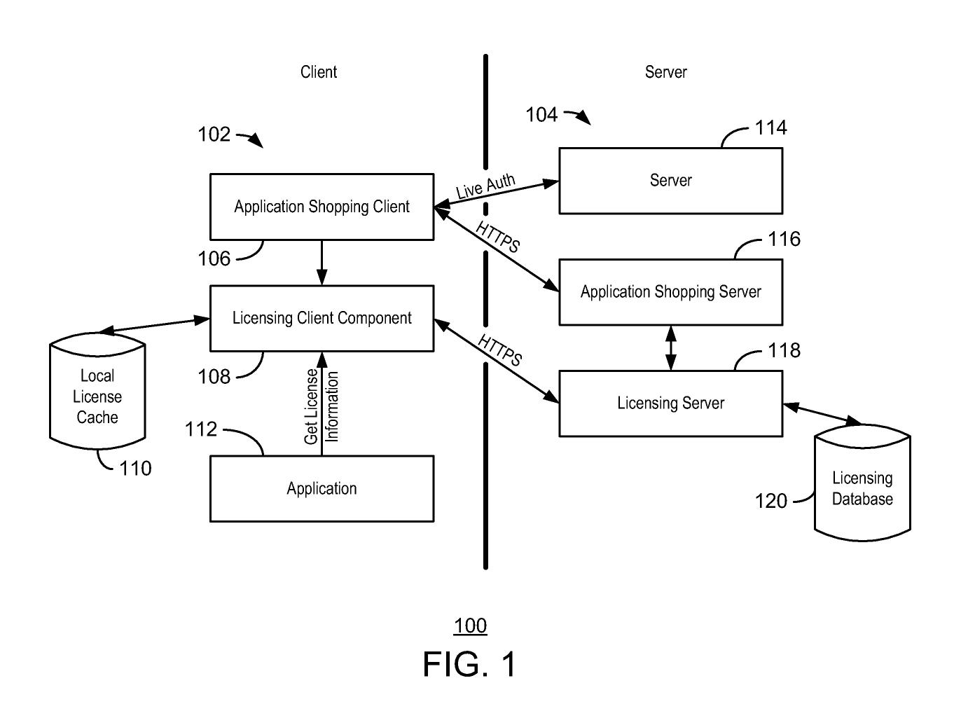

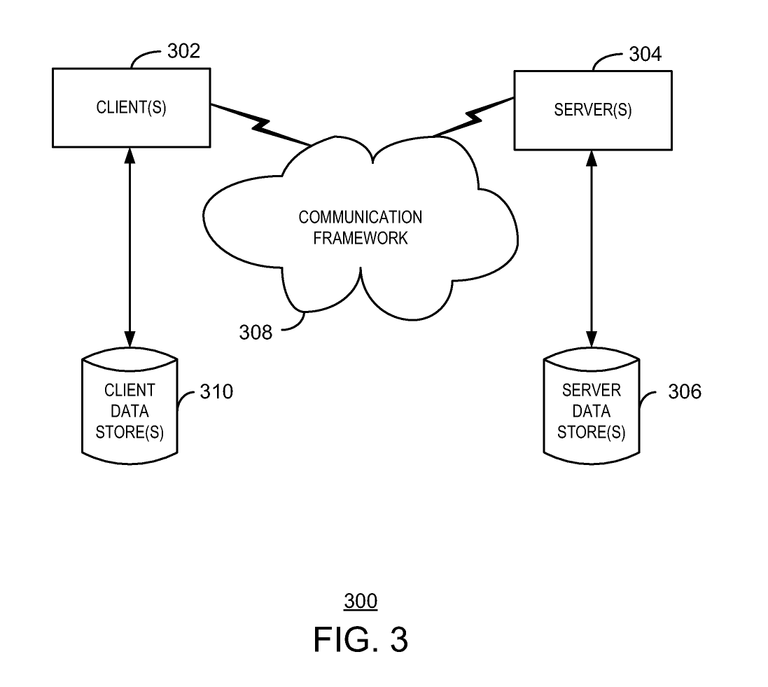

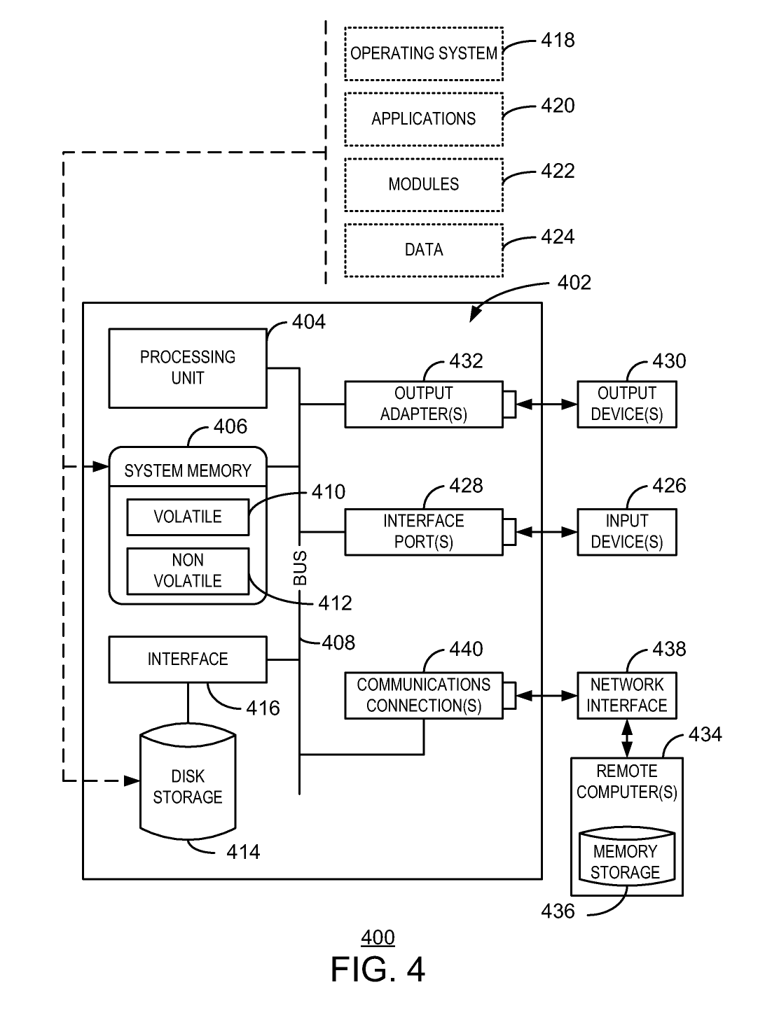

FIG. 1 is a block diagram of a system 100 in which remote disabling of licensed software according to the subject innovation may be practiced. The system 100 includes a client environment 102 depicted in a left panel of FIG. 1. As explained herein with reference to FIGS. 3 and 4, the client environment 102 may be implemented in a client computing system. A right panel of FIG. 1 depicts a server environment 104, such as a server computing system. The server environment 104 represented in the right panel may be disposed, for example, in a server computing system in a cloud computing environment. Moreover, the server environment 104 may be connected to a network such as the Internet.

The client environment 102 comprises an application shopping client 106. An example of an application shopping client 106 in a Windows® computing environment is a Windows® Store client. In an example embodiment, the application shopping client 106 may be implemented as a component or module of an operating system. The application shopping client 106 communicates with an authentication server and an application shopping server, as explained herein.

A licensing client component 108 is also included in the client environment 102. The licensing client component 108 maintains licensing information in a local license cache 110 of the client environment 102. The licensing client component 108 may exchange licensing information with a licensing server, as explained herein.

An application program 112 may be executed in the client environment 102. The application program 112 may obtain license information from the local license cache 110 via the licensing client component 108. The license information obtained from the local license cache 110 may govern aspects of the operation of the application program 112.

The server environment 104 includes a server 114 that, among other things, provides authentication when a user of the client environment 102 logs in. The user of the client environment 102 may have an account on the server 114, and may log in for the purpose of buying a software application. The user may provide a login credential such as an on-line ID as part of the logging on to the server 114. One example of the server 114 in a Windows® computing environment is a Windows Live® server. In a Windows® computing environment, the login credential may comprise a Windows Live® Passport Unique ID (PUID).

The server environment 104 includes an application shopping server 116 that may provide the user of the client environment 102 with a selection of software applications available for purchase. After being authenticated by the server 114, the application shopping client 106 may engage in a secure connection with the application shopping server 116. One example of the application shopping server 116 in a Windows® computing environment is a Windows® Store server.

The application shopping server 116 may have access to a licensing server 118. One example of the licensing server 118 in a Windows® computing environment is a Windows® Store licensing server. The licensing server 118 may in turn access license information stored in a licensing database 120.

According to the subject innovation, the licensing client component 108 of the client environment 102 creates a machine ID that is transmitted to the licensing database 120 as described herein the first time the user of the client environment 102 logs into the server 114. In particular, the machine ID may be transferred from the user's computer system in the client environment 102 via the licensing client component 108 and the licensing server 118.

In an example embodiment, the machine ID may be created using an identifier of a hardware component of the user's computer system, such as a serial number or the like. In one example, identifying information is created as a precursor to generating the machine ID itself. The identifying information and information related to a hardware component ID of the computer system (for example, a serial number) may be processed with a cryptographic process to create the machine D. In another example, a hardware identifier of the computer system may be hashed to create the machine ID. The machine ID may also be made immutable in the client environment 102 absent a complete reformat of the storage media that contain the machine ID.

The licensing server 118 maintains a record of each machine ID and corresponding user in the licensing database 120. If a user's computer system is stolen or otherwise lost, the user may report the loss via the corresponding account on the server 114. The next time a computer system with a machine ID that has been reported lost or stolen accesses the server environment 104, the licensing server 118 may issue a revocation of all licenses associated with that machine ID.

By way of example, if a computer system implementing the client environment 102 is reported stolen, a revocation of the license of the application program 112 is issued the next time the computer is logged on to the server 114. The revocation is communicated to the licensing client component 108 in the client environment 102, where it is stored in the local license cache 110 of the lost or stolen computer system. The next time the application program 112 is accessed on the lost or stolen system, the application program 112 will query the licensing client component 108 for the licensing status of the application program 112. When the revoked license status of the application program 112 is returned, the operation of the application program 112 is disabled.

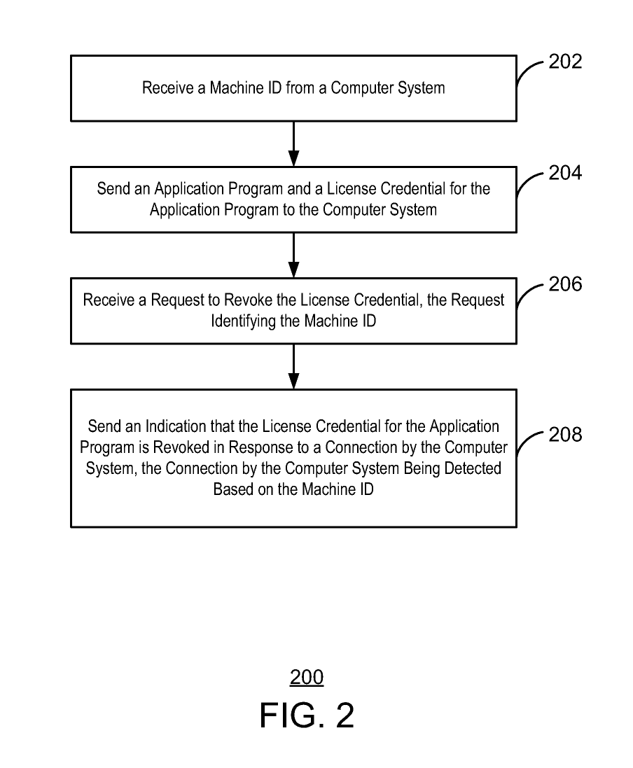

FIG. 2 is a process flow diagram of a method 200 of revoking a software license in a computing environment. At block 202, a machine ID from a computer system. As described herein, the machine ID is generated by the licensing client component 108 and transmitted to the licensing server 118 for storage in the licensing database 120. The machine ID may be transmitted when a user of the client environment 102 accesses the server environment 104, for example, to purchase software such as an application program.

At block 204, an application program and a license credential for the application program are sent to the computer system. Thereafter, the computer system becomes unavailable to the user because of theft or other loss.

According to the subject innovation, the user may report the loss of the computer system via a login account on the server 114. In this manner, a request to revoke the license credential is received by the licensing server 118, as indicated at block 206. In an example embodiment, the request identifies the machine ID that was previously provided for the computer system and stored in the licensing database 120. Upon receipt of the user's request, the license credential for the application program may be designated to be revoked. The revocation of the licensing credential may be stored in the licensing database 120.

If the computer system subsequently connects to the server 114, the connection is detected based on the machine ID of the computer system, as indicated at block 208. In an example embodiment, the licensing database 120 is consulted, and the revocation of the licenses associated with the machine ID of that particular computer system is noted. An indication that the license credential for the application program is revoked is sent to the computer system. As explained herein, the revocation of the license credential may be stored in the local license cache 110. The next time the application program is started on the computer system (presumably by a thief or other unauthorized user), the application program will query the licensing client component to determine the license status of the application program. Upon receiving the notification that the license credential has been revoked, the application program will no longer operate. In this manner, the thief or other unauthorized user is deprived of the use of the application program.

In one example embodiment, the rightful user may be granted a replacement license to use the application program on a new computer system. This may result in increased user satisfaction.

FIG. 3 is a block diagram of an exemplary networking environment 300 wherein aspects of the claimed subject matter can be employed. Moreover, the exemplary networking environment 300 may be used to implement a system and method of licensing software according to the subject innovation.

The networking environment 300 includes one or more client(s) 302. The client(s) 302 can be hardware and/or software (e.g., threads, processes, computing devices). As an example, the client(s) 302 may be computers providing access to servers over a communication framework 308, such as the Internet. The client(s) 302 may correspond to the client environment 102 shown and described herein with reference to FIG. 1.

The environment 300 also includes one or more server(s) 304. The server(s) 304 can be hardware and/or software (e.g., threads, processes, computing devices). The server(s) 304 may include network storage systems. The server(s) may be accessed by the client(s) 302. As described herein, the server(s) 304 may correspond to the server environment 104 shown and described herein with reference to FIG. 1.

One possible communication between a client 302 and a server 304 can be in the form of a data packet adapted to be transmitted between two or more computer processes. The environment 300 includes a communication framework 308 that can be employed to facilitate communications between the client(s) 302 and the server(s) 304.

The client(s) 302 are operably connected to one or more client data store(s) 310 that can be employed to store information local to the client(s) 302. The client data store(s) 310 may be located in the client(s) 302, or remotely, such as in a cloud server. One example of the client data store(s) 310 includes the local license cache 110 shown and described in FIG. 1. Similarly, the server(s) 304 are operably connected to one or more server data store(s) 306 that can be employed to store information local to the servers 304. An example of the server data store(s) 306 includes the licensing database 120 shown and described in FIG. 1.

With reference to FIG. 4, an exemplary operating environment 400 is shown for implementing various aspects of the claimed subject matter. The exemplary operating environment 400 includes a computer 402. The computer 402 includes a processing unit 404, a system memory 406, and a system bus 408. The computer 402 may form a portion of either the client environment 102 or the server environment 104.

The system bus 408 couples system components including, but not limited to, the system memory 406 to the processing unit 404. The processing unit 404 can be any of various available processors. Dual microprocessors and other multiprocessor architectures also can be employed as the processing unit 404.

The system bus 408 can be any of several types of bus structure(s) including the memory bus or memory controller, a peripheral bus or external bus, and/or a local bus using any variety of available bus architectures known to those of ordinary skill in the art. The system memory 406 comprises non-transitory computer-readable storage media that includes volatile memory 410 and non-volatile memory 412.

The basic input/output system (BIOS), containing the basic routines to transfer information between elements within the computer 402, such as during start-up, is stored in non-volatile memory 412. By way of illustration, and not limitation, non-volatile memory 412 can include read only memory (ROM), programmable ROM (PROM), electrically programmable ROM (EPROM), electrically erasable programmable ROM (EEPROM), or flash memory.

Volatile memory 410 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 402 also includes other non-transitory computer-readable media, such as removable/non-removable, volatile/non-volatile computer storage media. FIG. 4 shows, for example a disk storage 414. Disk storage 414 includes, but is not limited to, devices like a magnetic disk drive, floppy disk drive, tape drive, Jaz drive, Zip drive, LS-100 drive, flash memory card, or memory stick.

In addition, disk storage 414 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 414 to the system bus 408, a removable or non-removable interface is typically used such as interface 416.

It is to be appreciated that FIG. 4 describes software that acts as an intermediary between users and the basic computer resources described in the suitable operating environment 400. Such software includes an operating system 418. Operating system 418, which can be stored on disk storage 414, acts to control and allocate resources of the computer 402.

System applications 420 take advantage of the management of resources by operating system 418 through program modules 422 and program data 424 stored either in system memory 406 or on disk storage 414. It is to be appreciated that the claimed subject matter can be implemented with various operating systems or combinations of operating systems.

A user enters commands or information into the computer 402 through input device(s) 426. Input devices 426 include, but are not limited to, a pointing device (such as a mouse, trackball, stylus, or the like), a keyboard, a microphone, a joystick, a satellite dish, a scanner, a TV tuner card, a digital camera, a digital video camera, a web camera, and/or the like. The input devices 426 connect to the processing unit 404 through the system bus 408 via interface port(s) 428. Interface port(s) 428 include, for example, a serial port, a parallel port, a game port, and a universal serial bus (USB).

Output device(s) 430 use some of the same type of ports as input device(s) 426. Thus, for example, a USB port may be used to provide input to the computer 402, and to output information from computer 402 to an output device 430.

Output adapter 432 is provided to illustrate that there are some output devices 430 like monitors, speakers, and printers, among other output devices 430, which are accessible via adapters. The output adapters 432 include, by way of illustration and not limitation, video and sound cards that provide a means of connection between the output device 430 and the system bus 408. It can be noted that other devices and/or systems of devices provide both input and output capabilities such as remote computer(s) 434.

The computer 402 can be a server hosting various software applications in a networked environment using logical connections to one or more remote computers, such as remote computer(s) 434. The remote computer(s) 434 may be client systems configured with web browsers, PC applications, mobile phone applications, and the like.

The remote computer(s) 434 can be a personal computer, a server, a router, a network PC, a workstation, a microprocessor based appliance, a mobile phone, a peer device or other common network node and the like, and typically includes many or all of the elements described relative to the computer 402.

For purposes of brevity, only a memory storage device 436 is illustrated with remote computer(s) 434. Remote computer(s) 434 is logically connected to the computer 402 through a network interface 438 and then physically connected via a communication connection 440.

Network interface 438 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 440 refers to the hardware/software employed to connect the network interface 438 to the bus 408. While communication connection 440 is shown for illustrative clarity inside computer 402, it can also be external to the computer 402. The hardware/software for connection to the network interface 438 may include, for exemplary purposes only, internal and external technologies such as, mobile phone switches, modems including regular telephone grade modems, cable modems and DSL modems, ISDN adapters, and Ethernet cards.

An exemplary processing unit 404 for the server may be a computing cluster comprising Intel® Xeon CPUs. The disk storage 414 may comprise an enterprise data storage system, for example, holding thousands of impressions.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and/or events of the various methods of the claimed subject matter.

There are multiple ways of implementing the subject innovation, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the subject innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A method for revoking a license to software, comprising:
receiving a machine ID from a computer system;
sending an application program and a license credential for the application program to the computer system;
receiving a request to revoke the license credential, the request identifying the machine ID; and
sending an indication that the license credential for the application program is revoked in response to a connection by the computer system, the connection by the computer system being detected based on the machine ID.

2. The method recited in claim 1, comprising:
creating identifying information;
creating the machine ID by processing the identifying information and information related to a hardware component ID of the computer system using a cryptographic process.

3. The method recited in claim 1, comprising creating the machine ID by hashing a hardware component ID of the computer system.

4. The method recited in claim 1, comprising receiving user authentication information to initiate access to an account of a user of the computer system.

5. The method recited in claim 4, wherein the user authentication information comprises a Windows Live® Passport Unique ID (PUID).

6. The method recited in claim 1, comprising storing the machine ID in a licensing database.

7. The method recited in claim 1, wherein the indication that the license credential for the application program is revoked causes the application program to be disabled.

8. A system for revoking a license to software, comprising:
a processing unit; and
a system memory, wherein the system memory comprises code configured to direct the processing unit to:
receive a machine ID from a computer system;
send requested software and a license credential for the requested software to the computer system;
receive a request to revoke the license credential, the request identifying the machine ID;
designate the license credential for the requested software to be revoked in response to the request;
detect a connection by the computer system based on the machine ID; and
send to the computer system an indication that the license credential for the requested software is revoked.

9. The system recited in claim 8, wherein the machine ID is created by processing identifying information and information related to a hardware component ID of the computer system using a cryptographic process.

10. The system recited in claim 8, wherein the machine ID is created by hashing a hardware component ID of the computer system.

11. The system recited in claim 8, comprising code configured to direct the processing unit to receive user authentication information to initiate access to an account of a user of the computer system.

12. The system recited in claim 11, wherein the user authentication information comprises a Windows Live® Passport Unique ID (PUID).

13. The system recited in claim 8, comprising code configured to direct the processing unit to store the machine ID in a licensing database.

14. The system recited in claim 8, wherein the indication that the license credential for the application program is revoked causes the application program to be disabled.

15. One or more computer-readable storage media, comprising software licensing code configured to direct a processing unit to:
receive an identifier corresponding to a computer system;
send requested software and a license credential for the requested software to the computer system;
receive a request to revoke the license credential, the request including the identifier;
designate the license credential for the requested software to be revoked in response to the request;
detect a connection by the computer system based on the identifier; and
send an indication that the license credential for the requested software is revoked to the computer system.

16. The one or more computer-readable storage media recited in claim 15, wherein the identifier comprises a machine ID that is related to a hardware component ID of the computer system.

17. The one or more computer-readable storage media recited in claim 15, wherein the identifier comprises a machine ID that is created by hashing a hardware component ID of the computer system.

18. The one or more computer-readable storage media recited in claim 15, comprising code configured to direct the processing unit to receive user authentication information to initiate access to an account of a user of the computer system.

19. The one or more computer-readable storage media recited in claim 15, comprising code configured to direct the processing unit to store the identifier in a licensing database.

20. The one or more computer-readable storage media recited in claim 15, wherein the indication that the license credential for the application program is revoked causes the requested software to be disabled.
